(19) United States
(12) Patent Application Publication
(10) Pub. No.: US 2021/0303870 A1
(43) Pub. Date: Sep. 30, 2021

(54) VIDEO ANALYTIC SYSTEM FOR CROWD CHARACTERIZATION

(71) Applicant: NEC Laboratories America, Inc., Princeton, NJ (US)

(72) Inventors: Yi Yang, Princeton, NJ (US); Murugan Sankaradas, Dayton, NJ (US); Srimat Chakradhar, Manalapan, NJ (US); Ashutosh Jain, Markham (CA)

(21) Appl. No.: 17/208,572

(22) Filed: Mar. 22, 2021

Related U.S. Application Data
(60) Provisional application No. 62/994,928, filed on Mar. 26, 2020.

(51) Int. Cl. G06K 9/00; G06Q 30/02

(52) U.S. Cl. CPC G06K 9/00778; G06Q 30/0246; G06Q 30/0254; G06K 9/00718

(57) ABSTRACT

A computer-implemented method for characterizing a crowd that includes recording a video stream of individuals at a location having at least one reference point for viewing; and extracting the individuals from frames of the video streams. The method may further include assigning tracking identification values to the individuals that have been extracted from the video streams; and measuring at least one type classification from the individuals having the tracking identification values. The method may further include generating a crowd designation further characterizing the individuals having the tracking identification values in the location, the crowd designation comprising at least one measurement of probability that the individuals having the tracking identification values in the location view the at least one reference point for viewing.

### RELATED APPLICATION INFORMATION

This application claims priority to 62/994,928, filed on Mar. 26, 2020, incorporated herein by reference in its entirety.

### BACKGROUND

### Technical Field

The present invention relates to characterizing crowds of people, and more particularly characterizing a crowd of people by at least one of population, dwell time and opportunity to see (OTS).

### Description of the Related Art

The purpose of advertising is to influence people into changing/enforcing behavior. In order to produce maximum effect using minimum resources promoters aim to tailor the message to the target audience and to target message delivery to the appropriate audience. Characterization of crowds of people within regions, e.g., buildings, can facilitate how advertising is targeted to regions.

### SUMMARY

According to an aspect of the present invention, a method is provided for characterizing crowds. In one embodiment, the computer-implemented method for characterizing the crowd includes recording a video stream of individuals at a location having at least one reference point for viewing, and extracting the individuals from frames of the video streams. The method can further include assigning tracking identification values to the individuals that have been extracted from the video streams; and measuring at least one type classification from the individuals having the tracking identification values. In one embodiments, the method further generates a crowd designation further characterizing the individuals having the tracking identification values in the location. The crowd designation can include at least one measurement of probability that the individuals having the tracking identification values in the location view the at least one reference point for viewing.

According to another aspect of the present invention, a system is provided for characterizing a crowd method. The system may include a hardware processor; and a memory that stores a computer program product. The computer program product when executed by the hardware processor, causes the hardware processor to record a video stream of individuals at a location having at least one reference point for viewing; and extract the individuals from frames of the video streams. In some embodiments, the hardware processor also assigns tracking identification values to the individuals that have been extracted from the video streams; and measures at least one type classification from the individuals having the tracking identification values. The system can further include generating a crowd designation further characterizing the individuals having the tracking identification values in the location. The crowd designation can include at least one measurement of probability that the individuals having the tracking identification values in the location view the at least one reference point for viewing.

According to yet another embodiment of the present invention, a computer program product for characterizing a crowd is described. The computer program product includes a computer readable storage medium having computer readable program code embodied therewith. The program instructions are executable by a processor to cause the processor to record a video stream of individuals at a location having at least one reference point for viewing. The program instructions can also include to extract, using the processor, the individuals from frames of the video streams; and assign, using the processor, tracking identification values to the individuals that have been extracted from the video streams. In some embodiments, the program instructions can also include to measure, using the processor, at least one type classification from the individuals having the tracking identification values; and to generate, using the processor, a crowd designation further characterizing the individuals having the tracking identification values in the location. The crowd designation includes at least one measurement of probability that the individuals having the tracking identification values in the location view the at least one reference point for viewing.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram illustrating an exemplary environment, where a system characterizing a crowd of individuals in determining at least an opportunity to see (OTS) value for individuals having at one type classification that can be used to configure targeted advertising.

FIG. 2 is a block diagram illustrating a high-level system for characterizing a crowd, in accordance with an embodiment of the present invention.

FIG. 3 is a block diagram illustrating a detailed view of the identity extractor from the system for characterizing a crowd depicted in FIG. 2, in accordance with an embodiment of the present invention.

FIG. 4 is a block diagram illustrating a detailed view of a feature extractor from the system for characterizing a crowd depicted in FIG. 2, in accordance with an amendment of the present invention.

FIG. 5 is a block diagram illustrating a detailed view of a crowd characterizing designator from the system for characterizing a crowd depicted in FIG. 2, in accordance with an amendment of the present invention.

FIG. 6 is a block diagram showing an exemplary processing system that can incorporates the system architecture for characterizing a crowd that is depicted in FIG. 2, in accordance with an embodiment of the present invention.

FIG. 7 is a block/flow diagram depicting a high-level method for characterizing a crowd, in accordance with an embodiment of the present invention.

FIG. 8 is a block/flow diagram illustrating one embodiment of a method for calculating crowd population, dwell time and the opportunity to see for individuals as part of the method for characterizing a crowd.

### DETAILED DESCRIPTION OF PREFERRED EMBODIMENTS

In accordance with embodiments of the present invention, systems and methods are provided to/for a real-time analytic system for characterizing crowds, which can support multiple applications including crowd counting, dwell time and OTS (Opportunity to See). “Crowd counting” is defined as the number of persons in a location. “Dwell time” is defined as the time duration of a person stay in a location. OTS is used to measure the success of advertising by monitoring the behavior of viewers in real time, and needs additional information such as the position of the individuals being analyzed relative to locations have advertisements to be observed, e.g., the opportunity to see (OTS) may consider the angle of each person facing advertisements.

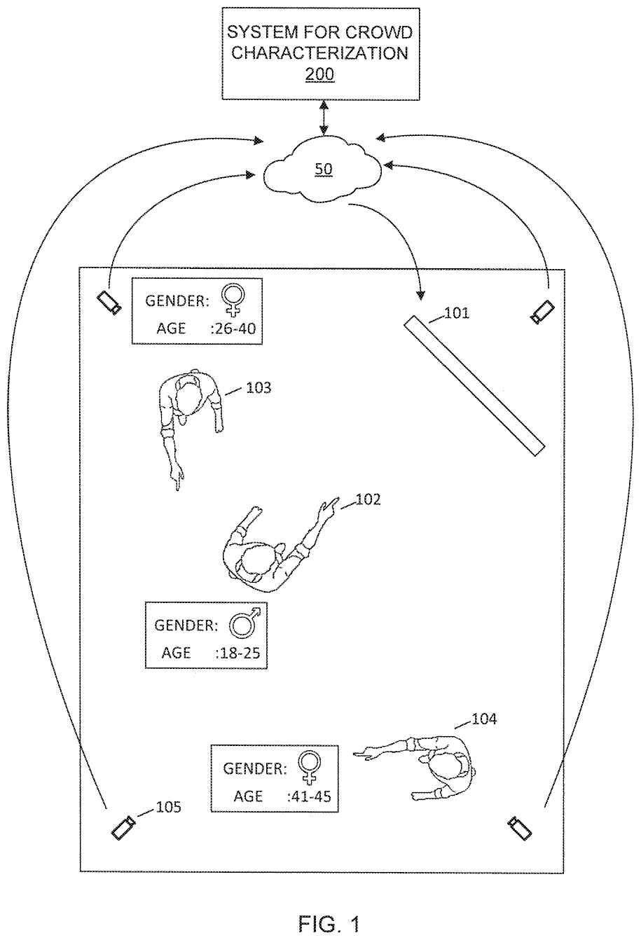

Referring now to FIG. 1, an exemplary monitored environment is shown 100. The monitored environment includes at least one point of reference 101. The point of reference can serve as the placement of an advertisement. Although one point of reference is depicted, the present disclosure is not limited to only this example. Any number of points of reference may be included in the monitored environment.

The methods, systems and computer program products measure not only the number of people within the monitored environment 100, e.g., a population density, but can also provide a characterization of how long individuals say within the monitored environment, and provide a measurement of the opportunity that a person would see the advertisement, e.g., by looking at the point of reference. The methods, systems and computer program products can employ a series of camera's 105 to record individuals 102, 103, 104 in the monitored environment 100. The recorded videos are extracted into frames by the system for characterizing the crowds 200. In some embodiments, the system for characterizing crowds 200 can be in communication with the cameras 105 across a network 50. The network 50 may be any appropriate network, for example a local area network. In some examples, the network 50 may be a wireless network, such as a mesh network.

The characterization can include crowd density, e.g., how many individuals 102, 103, 104 are in the monitored environment 100. The characterization can also include the dwell time for the people within the monitored environment, e.g., how long the individuals 102, 103, 104 are present within the monitored environment 100. The characterization can also include a measurement of the opportunity to see (OTS) for the individuals 102, 103, 104. The characterization of the crowds may also include a measurement of the crowd type. This type of characterization may include data on the gender and age of the individuals 102, 103, 104. The above aforementioned data is all measured from obtained from analyzing the video camera feeds and tracking the individuals 102, 103, 104.

For example, an observing individual 102 may be positioned within the monitored environment 100 having a posture placing their attention on the at least one point of reference 101, while two other non-observing individuals 103, 104 do not have a posture that would place their attention on the point of reference 101. The non-observing individuals 103, 104 may not be facing the point of reference, or they may be traveling in a direction that is not conducive to viewing the point of reference 101. The observing individual 102 may have a pose indicative of

The ability to identify individuals from video frames, and to determine the position of the individuals, as well as the pose of the individuals relative to the point of reference 101 can be provided by computer vision methods.

Both the observing individual 102, and the non-observing individuals 103, 104, can all be measured and included in the population for the crowd. Although the example depicted in FIG. 1 only includes three individuals, this is only one example, and the methods, systems and computer program products of the present disclosure can measure any number of individuals in the monitored location 100. Although FIG. 1 only identifies one monitored environment, the methods, systems and computer program products can be simultaneously applied to any number of environments to be monitored. The environment 100 to be monitored may be buildings, a room in a building, a portion of a room, etc. In some examples, by proving the population of the crowds in each monitored location 100, the crowd characterizing system can provide information of which of the monitored locations can have the largest audience for viewing targeted advertisements.

The system for characterizing the crowds 200 can assign tracking identifications to the individuals in the monitored space. By tracking the individuals in the monitored environment, a dwell time can be provided for each of the individuals 102, 103, 104. Tracking can employ individual identification from the video frames, facial recognition, identification tagging of individuals matched to the facial images measured by the facial recognition and time tracking. In the example depicted in FIG. 1, the observing individual 102 is stationary while viewing the point of reference 101. Still referring to FIG. 1, the non-observing individuals 103, 104 are moving, e.g., traveling through the monitored space. In the example depicted in FIG. 1, the observing individual 102 in this scenario will have a high dwell time, while the non-observing individuals 103, 104 will have a low dwell time.

Taking into account the number of individuals in the crowd, the dwell time for the individuals, and the positioning and posing of the individuals, e.g., opportunity to see, the crowd characterizing system can designate which monitored spaces 100 have a point of reference 101 that is best for targeted advertising.

Further, in some embodiments, the using crowd characterization system using the cameras 105 can also measure at least one type classification from the individuals 102, 103, 104. The crowd designation can be by at least one of gender and age. The gender and age of the individuals 102, 103, 104 can be measured using the camera's and computer vision.

Computer vision is concerned with the automatic extraction, analysis and understanding of useful information from a single image or a sequence of images. It involves the development of a theoretical and algorithmic basis to achieve automatic visual understanding. Computer vision can be provided by digital systems that can process, analyze, and make sense of visual data, e.g., data from frames from the video of the individuals taken by the cameras 105. In some embodiments, machines attempt to retrieve visual information, handle it, and interpret results through software algorithms. In some embodiments, the software algorithms employ pattern recognition and can be configured to provide age estimates and genders for the individuals in the video. For example, referring to FIG. 1., the crowd characterizing system can measure that the observing individual 102 is a male having an age ranging from 18-25. Similarly, the crowd characterizing system 200 can characterize one of the non-observing individuals 103 as being a female having and age ranging from 26-40 years of age, and can characterize the second of the non-observing individuals 104 as being a female and having an age ranging from 41-45 years of age.

Using the crowd characterization for the population of the crowd, the dwell time for the individuals in the crowd, and the opportunity to see (OTS) values, as well as the characterization types, e.g., gender and age, of the individuals in the crowd, the crowd characterization system 200 can provide at least one measurement of probability that the individuals in the location being monitored will view the at least one reference point 101. More specifically, using the likelihood that the individuals will view the reference point 101 of the locating being monitored, and the type characterization, e.g., gender and/or age, of the individuals being tracked, the characterization system 200 can launch targeted advertising to the crowd. More specifically, the characterization system 200 can launch advertising having a subject that matches the age and gender of the individuals at reference point of a location being monitored having a high likelihood of being viewed by individuals. The characterization system 200 may include an interface for communicating over the network 50 to an application that displays advertising at the point of reference. The application using the signaled measurement of probability that the individuals in the location being monitored will view the at least one reference point 101, and the signaled characterization of the type characteristics of the individuals in the crowd, e.g., age and gender, will provide transmit the appropriate advertising subjects to be displayed at the at least one reference point 101. This can be done in real time while the crowd is being recorded by the cameras 105.

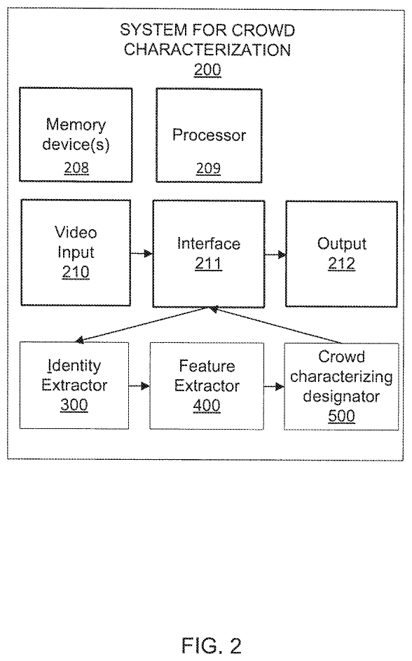

Referring now to FIG. 2 a block diagram illustrating a high-level system for characterizing a crowd 200 (also referred to as crowd characterization system 200) is shown. To provide the measurement of probability that the individuals in the location being monitored will view the at least one reference point 101, and the signaled characterization of the type characteristics of the individuals in the crowd, the crowd characterization system 200 may include an identity extractor 300, a feature extractor 400 and a crowd characterizing designator 500. Using these elements, the crowd characterization system 200 extracts frames from an input video steam, detect persons and faces from each frame, and then extract data from the detected persons and faces. The crowd characterization system 200 can employ multiple deep learning and computer vision engines to extract multiple features from videos. Both person detection and face detection can be employed to extract information, and then connect faces with persons. The multiple applications can be supported in our system while not increasing the hardware cost.

The crowd characterization system 200 also includes an interface 211 for receiving a video input 210 from the cameras 105. The interface 211 provides communications from the cameras 105 to the crowd characterization system 200, which includes feeding the video feed to the identity extractor 300 of the crowd characterization system 200. The interface 211 of the crowd characterization system 200 also includes an output 212 for the measurement of probability that the individuals in the location being monitored will view the at least one reference point 101, and the signaled characterization of the type characteristics of the individuals in the crowd. The output 212 can be in communication with an application that responsive to the measurement of probability that the individuals in the location being monitored will view the at least one reference point 101, and the signaled characterization of the type characteristics of the individuals in the crowd, transmits the appropriate advertising subjects to be displayed at the at least one reference point 101. The crowd characterization system 200 is a real-time analytic system that can support multiple applications including crowd counting, dwell time and OTS (Opportunity to See).

The crowd characterization system 200 may also include at least one hardware processor 209 and at least one memory device 208. As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

Still referring to FIG. 2, in some embodiments, the input to the crowd characterization system 200 is through the video input 210, which receives frames which come from a video stream in real-time. The identity extractor 300 analyzes the frames to detect people and faces. The identity extractor 300 can also add a track identification (ID)(which is anonymous) to each detected person and face to connect persons across different frames. The identity extractor 300 provides the input to the feature extractor 400. The feature extractor 400 detects information, e.g., type characterization, such as gender and age, from the people and faces that were input into the feature extractor 400 from the identity extractor. The feature extractor 400 includes multiple detectors including age and gender detector, and face pose detector. In some embodiments, the features extractor 400 provides that each person has an associated pose angle and age/gender information. The output of the feature extractor 400 provides an input to the crowd characterizing designator 500. The crowd characterizing designator 500 prepares the final output result for different applications. For crowd counting, the crowd characterizing designator 500 outputs the number of persons for each region. For dwell time, the crowd characterizing designator 500 outputs the duration of each person staying in a region. For OTS, the crowd characterizing designator 500 outputs the impression time based on the face pose and dwell time.

In one example, the system for characterizing a crowd 200 includes the hardware processor 208, and the memory device 209 that stores a computer program product, which, when executed by the hardware processor 209, causes the hardware processor to record a video stream of individuals 102, 103, 104 at a location 100 having at least one reference point 101 for viewing. In some embodiments, the memory and hardware device in combination with the identity extractor 300 extract the individuals from frames of the video streams, and assign tracking identification values to the individuals that have been extracted from the video streams. In some embodiments, the feature extractor 400 with the hardware processor 209 and memory 208 measure at least one type classification from the individuals having the tracking identification values. In some embodiments, the crowd characterization designator generates a crowd designation further characterizing the individuals having the tracking identification values in the location, the crowd designation including at least one measurement of probability that the individuals having the tracking identification values in the location view the at least one reference point for viewing.

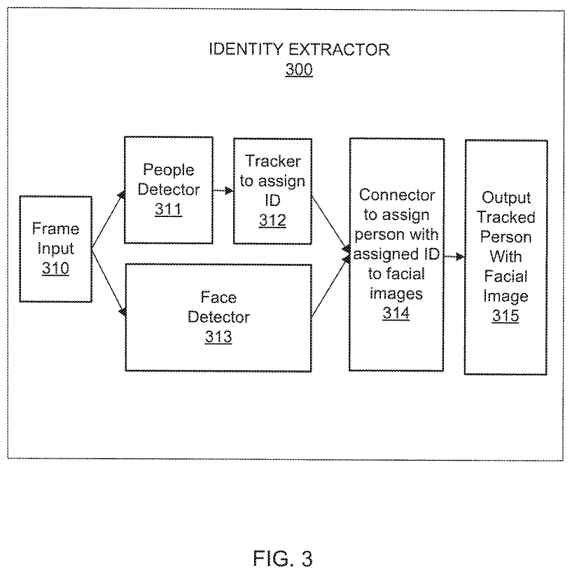

Referring to FIG. 3 a detailed view is illustrated for one embodiment of the identity extractor 300 used in the system for characterizing a crowd 200. The identity extractor 300 includes a frame input 310, which receives the video stream, e.g., in real time, from the video input 210 of the crowd characterization system 200. The identity extractor 300 includes a people detector 311, a face detector 313 and a tracker to assign identification (ID) 312.

As illustrated in FIG. 3, the frames from the frame input are fed to both the face detector 313 and the people detector 311.

The person detector 311 can perform person detection on video frames on the video frames. In one example, the person detector 311 can perform person detection 410 using a neural network—based machine learning system that recognizes the presence of a person-shaped object within a video frame and that provides a location within the video frame, for example as a bounding box. The people detector 311 can output the location of each person (individual) in a frame.

The output of the people detector 311 may be to the tracker to assign identification 312. The locations of detected people within the frames from the people detector 400 are provided to the tracker to assign identification 312. Person tracking tracks the occurrence of particular individuals across sequences of images. The tracker 312 tracks each person (individual) so that each person has a unique track identification (id). The track identification is anonymous label. It is not the actual identity of the individual being tracked.

The face detector 313 can perform facial recognition on the video frames. Facial detection may be performed using, e.g., a neural network—based machine learning system that recognizes the presence of a face within a video frame and that provides a location within the video frame, for example as a bounding box. Face recognition may include filtering a region of interest within a received video frame, discarding unwanted portions of the frame, and generating a transformed frame that includes only the region of interest (e.g., a region with a face in it). Face detection can furthermore perform face detection on the transformed frame either serially, or in parallel. In some embodiments, for example when processing video frames that include multiple regions, the different regions of interest can be processed serially, or in parallel, to identify faces. The face detector 313 can provide the locations of all faces in a frame.

The output of the face detector 313 and the people detector 311 provide the input to the connector 314 to assign the persons with assigned identification to facial images. In some embodiments, the connector 314 using the locations of faces and persons connects each person to the person's face. For example, if a face location, which is a bounding box, is within and on the top part of a person's location (bounding box), then the face is connected to the person.

Referring to FIG. 3, after the connector 314 to assign the persons with assigned identification to facial images, the identity extractor 300 generates the information of persons, and for each person, we have a track id, the location of the person, the location of face. The information is provided as the output tracked person with facial image 315, which is communicated to the feature extractor 400.

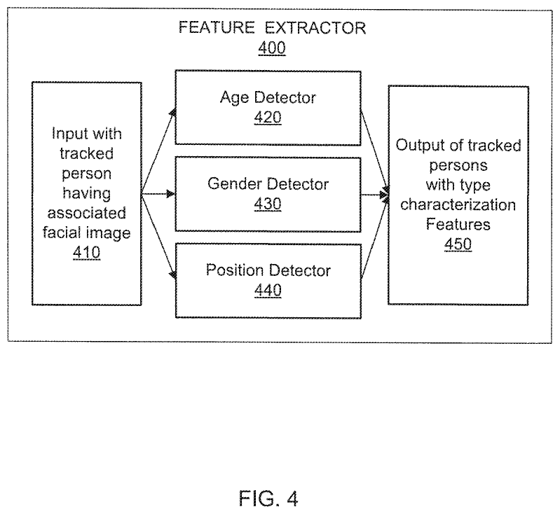

FIG. 4 illustrates a detailed view of one embodiment of a feature extractor 400 from the system 200 for characterizing a crowd that is depicted in FIG. 2. In some embodiments, the feature extractor 400 includes an age detector 420, a gender detector 430 and a position detector 440. The input 410 to each of these detectors is the output of the tracked persons with faces from the identity extractor 300. The output 450 from the feature extractor is an output of tracked persons with type characterization features, e.g., gender, age and/or position.

The age detector 420 can use deep learning to extract the age number from the images, e.g., face images, of the person provided by the input 410. The posture, geometry, pattern, and facial wrinkles are all elements that facilitate the prediction of the user's age. Using the above noted characteristics from imaging, the age of the individuals can be estimated using artificial intelligence. The artificial intelligence may employ deep-learning architectures, such as deep neural networks, deep belief networks, recurrent neural networks and convolutional neural networks applied to computer vision to provide an age estimate.

The gender detector 430 can use deep learning to extract the gender, e.g., male or female, from the images, e.g., facial images, of the person provided by the input 410. The posture, geometry, pattern, and facial are all elements that facilitate the prediction of the user's age. Using the above noted characteristics from imaging, the age of the individuals can be estimated using artificial intelligence. The artificial intelligence may employ deep-learning architectures, such as deep neural networks, deep belief networks, recurrent neural networks and convolutional neural networks applied to computer vision to provide a gender characterization.

The position detector 440 can characterize the position of the individuals 102, 103, 104 relative to the point of reference 101. For example, the position detector 440 can employ computer vision techniques to extract from the images provided by the input 410 the angle of the individuals facing the cameras 105. For example, considering the positioning of a camera 105 mounted proximate to the point of reference 101, e.g., the camera 105 installs on top of the monitor at the point of reference 101 used to show advertisements, the angle of individuals facing the camera is considered as the angle of the facing the advertisements, and therefore can indicate whether the person is watching the point of reference including advertisements or not.

Still referring to FIG. 4, the type characterization features, e.g., gender, age and/or position, from each of the age detector, gender detector and position detector 440 are then collected and output from the feature extractor 400. The output 450 providing tracked persons with type characterization features provides the input to the crowd characterizing designator 500.

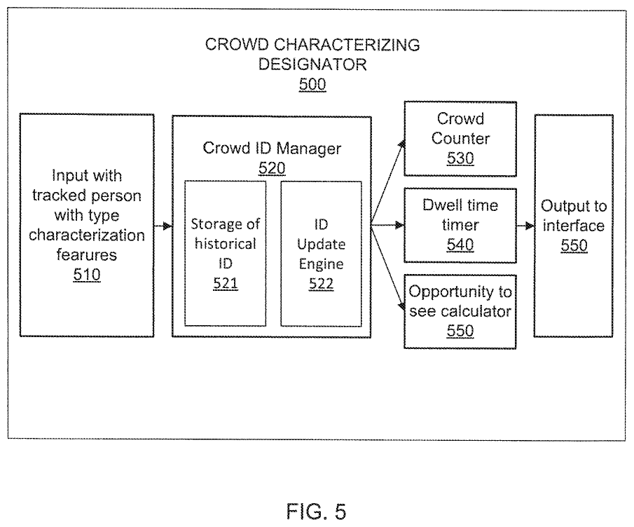

FIG. 5 is a detailed view of a crowd characterizing designator 500 from the system for characterizing a crowd depicted in FIG. 2. The crowd characterization designator 500 employs the tagged individuals having identification provided by the people detector 400, and the individual type characterization for the tagged individuals, to calculate crowd characterizations including a characterization for the population of the crowd, the dwell time for individuals in the crowd, and the opportunity to see (OTS) for the individuals in the crowd.

The tracking of the tagged individuals having the identification provided by the people detector can be provided by a crowd identification (ID) manager 520. The crowd ID manager 520 includes a database of historical individuals having a tagged identification (ID). The input 510 to the crowd characterizing designator 500 is from the output of the feature extractor 400. The input 510 includes tracked persons with type characterization features. The input 510 is to a crowd identification (ID) manager 520. The input 510 includes all persons in the current frames, and each person has a track ID (Id), face and person locations, age gender information, and face pose angle.

The crowd ID manager 520 includes storage for historical identifications (IDs) 521. The storage for historical identifications (IDs) 521 may be a table that includes all current active persons, and each person has a start time, end time, and impress time. The start time means the time of the person first seen in the camera, the end time means the time of the person last seen in the camera, the impression time is the number of seconds that the person's face angle to the camera is less than a threshold, named as impression threshold. For each person from the input 510 having a track ID, the crowd ID manager 520 checks whether the person's track id exists in the storage for historical identification (IDs) 521, e.g., exists in the history table or not.

The crowd ID manager 520 also includes a crowd updater 522. The crowd updater 522 assigns updates existing track IDs in the storage for historical identifications (IDs) 521, adds new track IDs to the storage for historical identifications (IDs) 521, and deletes track IDs from the storage for historical identifications (IDs) 521. The update, addition and delete functions performed by the crowd updater 522 can be dependent upon the input of new data received by the crowd characterization system 200 starting from the video being taken by the cameras 105.

If the crowd ID manager 520 receives a person having an existing track ID in the storage for historical identifications (IDs) 521, the crowd updater 522 updates the last seen time (end time) of the person in the table of the storage 521 to current time, and if the face angle is less than the impression threshold, the updater 522 can increase the person's impression time by a factor, e.g., a factor of 1 second. In some examples, for impression time, the updater 522 can check once every second, because the updater 522 will add 1 second when increasing due to impression time.

If the crowd ID manager 520 receives a person having a new track ID that is not existing in the storage for historical identifications (IDs) 521, the crowd updater 522 adds the new track ID to the storage 521, e.g., adds to the new track ID to the table within the storage 521, and sets the start time and end time to current time. In this instance initialize the impression time to 0.

The crowd ID manager may also include a function for removing track IDs that are not longer relevant. For example, the crowd updater 522 removes a track ID from the storage 521, e.g., adds to the new track ID to the table within the storage 521, if its end time is not updated for a while, for example, 3 seconds.

Using the three scenarios, the crowd ID manager 500 provides an updated history table which is stored in the storage for historical identifications (IDs) 521. For all persons in the updated history table in the storage for historical identifications (IDs) 521, the crowd ID manager 500 verifies them with regions of interest, e.g., the different monitored locations 100. Each region of interest, e.g., within the monitored locations 100 including the point of interest 101, is a bounding box in the video frame, and it defines a part of the video frame that is partially interested for use as a point of reference 101 for targeted advertising. The location of each person is used to determine whether this person belongs one region of interest or not. The whole frame can function as the default region of interest, unless customers specify. The crowd ID manager employs the tracked IDs and timing information correlated to the different video cameras 105 (which can be specific to the monitored locations 100) to determine which regions the people being tracked are present in, and can determine the times at which the persons being tracked are within the regions being monitored.

For each region of interest, e.g., monitored location 100 (such as point of reference 101, the crowd characterizing designator 500 outputs results for three applications using the tracking information, e.g., tracking ID for each region of interest, and the associated type characteristics. The three applications include a crowd counter 530, a dwell time timer 540, and an opportunity to see calculator 550.

The crowd characterizing designator 500 uses a crowd counter 530 that totals the number of persons within each region of interest, e.g., monitored location 100 (such as point of reference 101). The crowd counter 530 counts the number of the persons using the number of track identification (id).

The crowd characterizing designator 500 also employs a dwell time timer 540. The dwell time timer 540 performs dwell time calculations. The dwell time timer 540 measures the time difference between end time and start time as the duration of a person, e.g., a person having a track identification (id), staying before camera 105.

The crowd characterizing designator 500 also employs an opportunity to see (OTS) calculator 550. The OTS results include the dwell time, and the impression time. The OTS calculator 550 also incorporates the demographic information, e.g., age, gender and position (e.g., the angle of the person facing the point of interest 101). This information is obtained from the type characteristics that have been tied to the track identification. The outputs from the crowd counter 530, dwell time timer 540 and the OTS calculator 550 can all be automatically launched from the crowd characterizing designator 500 to an application that matches this information to advertising content. The matched advertising content is displayed at the point of reference. This provides targeted advertising to the type characteristics, gender and age, of the individuals being tracked at the appropriate locations being monitored and times.

Depending on the user's needs for the crowd characterization system 200, the system supports different configurations for different applications. For example, if a customer only needs the crowd counting function provided by the crowd counter 530, the configuration of the system 200 can only enable the people detector 311, and disables other detectors including people tracker 312, face detector 313, age detector 420, gender detector 430, and pose detector 440. In the manner, the hardware cost of the system can be reduced significantly. For dwell time, we only need to enable people detector 311 and people tracker 312 without any face-related detectors, such as the face detector 313, age detector 420, gender detector 430, and position detector 440. In some embodiments, the system 300 employs all detectors for calculating the opportunity to see (OTS), which would include the people detector 311, the people tracker 312, the face detector 313, age detector 420, gender detector 430, and position detector 440.

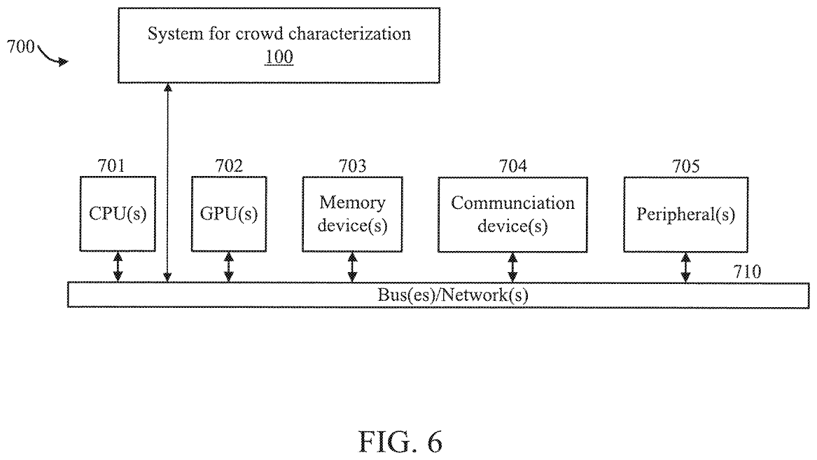

FIG. 6 is a block diagram showing an exemplary processing system that can incorporates the system architecture for characterizing a crowd that is depicted in FIG. 2.

The processing system 700 includes a set of processing units (e.g., CPUs) 701, a set of GPUs 702, a set of memory devices 703, a set of communication devices 704, and set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., WIFI, etc.) adapters, etc.). The peripherals 705 can include a display device, a user input device, a printer, an imaging device, and so forth. Elements of processing system 700 are connected by one or more buses or networks (collectively denoted by the figure reference numeral 710). The crowd characterization system 200 may be in communication with the bus 710.

In an embodiment, memory devices 703 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

Of course, the processing system 700 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described below with respect to various elements and steps relating to the present invention that may be implemented, in whole or in part, by one or more of the elements of system 700.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

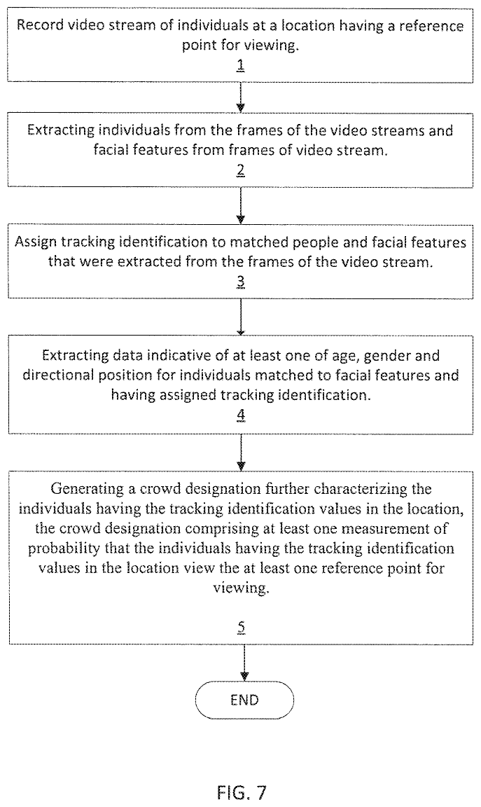

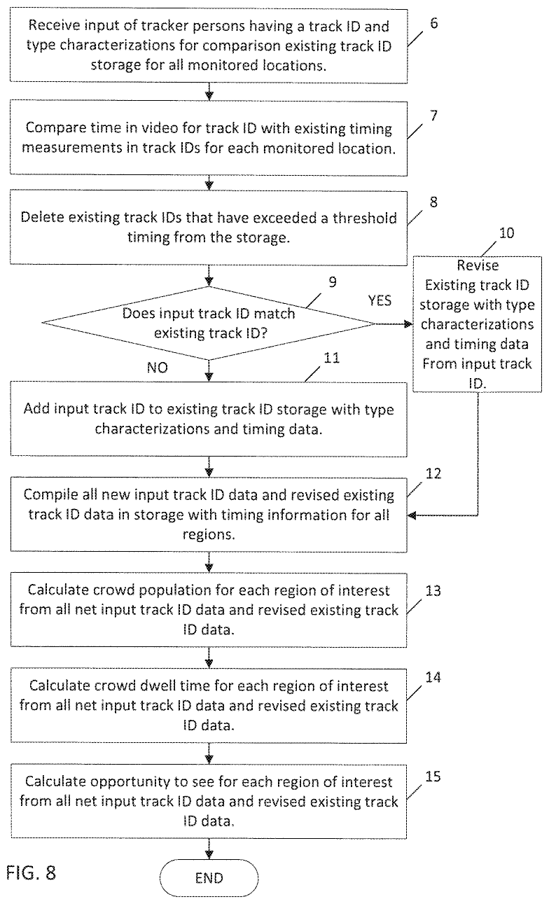

Referring now to FIGS. 7 and 8, methods for crowd characterization are shown. The method may begin with block 1, which includes recording the video stream of individuals at a location, e.g., monitored location 100, having a reference point 101 for viewing. The video may be recorded using camera 105, as depicted in FIG. 1. Further description of the cameras 105, locations being filmed 100 and types of individuals 103, 103, 104 being filmed by the cameras 105 is provided in the above description of FIG. 1.

At block 2, the method continues with extracting individuals from the frames of the video streams, and from extracting facial features from the frames of the video streams. Facial feature detection can be provided using computer vision, and pattern recognition. In some embodiments, facial feature detection is provided by the face detector 313 of the identity extractor 300 that is described with reference to FIGS. 2 and 3. Person detection can also be provided using computer vision. In some embodiments, person detection is provided by the people detector 311 of the identity extractor 300 that is described with reference to FIGS. 2 and 3.

Person detection can be applied to the frames of the video stream in real time, to detect people and faces. A track id is also added to each detected person and face to connect persons across different frames as noted in block 3 of FIG. 7. Block 3 includes assigning tracking identification to matched people and faces that were extracted from the frames of the video stream. The tracking identification is anonymous. It is not identification in the sense of a person's name, but is instead a consistent tag by which a person can be tracked from fame to frame in the frames of the video streams being analyzed. Further details on the assignment of tracking identification is provided in the description of the tracker to assign ID 312 that is depicted in FIG. 3. Further details on matching the people from the frames having the assigned tracking ID to facial images extracted from the frames of the videos is provided above in the description of the connector 314 in FIG. 3, in which the connector 314 is to assign persons with assigned ID to facial images.

Referring to FIG. 7, the method can further include extracting data indicative of at least one of age, gender and directional position for individuals matched to facial features and having assigned tracking identification at block 4. The data indicative of age, gender and directional position may be referred to as type characterization features for the individuals being tracked. In some embodiments, the type characterization features are extracted with a feature extractor 400 that includes multiple detectors including age detector 420 and gender detector 430, and face pose detector (also referred to as a position detector 440), as described with reference to FIG. 4. In some embodiments, extracting the data at block 4 can result in each person having a track ID with an associated pose angle and age/gender information. For example, a deep learning based age detector 420 may be employed to extract the age number from the face of the person. For example, a deep learning based gender detector 430 to extract the gender from the face of the person. For example, a position detector 440 can detect the angle of the person facing the camera. In some examples, the methods can include installing at least one camera 105 installs on top of a monitor used to show advertisements at the point of reference 101. In this example, the angle of facing the camera is considered as the angle of the facing the advertisements and therefore it indicates whether the person is watching the advertisements or not.

The method may continue to block 5 of FIG. 7, which includes generating a generating a crowd designation further characterizing the individuals having the tracking identification values in the location, the crowd designation including at least one measurement of probability that the individuals having the tracking identification values in the location view the at least one reference point for viewing.

FIG. 8 illustrates one embodiment of a method for calculating crowd population, dwell time and the opportunity to see for individuals as part of the method for characterizing a crowd. Following block 5 of FIG. 7, the tracked data may for the individuals 102, 103, 104 being record by the cameras 105 in the areas being monitored 100 can include all persons in the current frames, and each person may have a track id, as well as face and person locations, age gender information, and face pose angle. In some embodiments, this data can provide the input to a crowd characterizing designator 500, as described in FIG. 5. The crowd characterizing designator 500 can include storage for historical ID 521 and an ID update engine 520, which in some embodiments can maintain a history table of ID correlating to the individuals 102, 103, 104 being tracked in the locations being monitored 100. The table can include all current active persons, and each person has a start time, end time, and impress time. The start time means the time of the person first seen in the camera, the end time means the time of the person last seen in the camera, the impression time is the number of seconds that the person's face angle to the camera is less than a threshold, named as impression threshold.

The person's track id is checked to see if it exists in the history table. Referring to block 7, this can include checking the time for the video frame for the tracked ID and comparing the time of the new video frame with the existing timing measurements in track IDs for each monitored location.

Referring to block 8, an entry in history table can be removed if its end time is not updated for a set period of time which designates the individual being tracked is no longer within a location being monitored, for example, a time period of 3 seconds without being captured in a video frame.

At block 9, for each person having a currently tracked ID, the method can check whether the person's track ID already exists in the history table or not at block 9. If yes, e.g., the track ID exists in the stored history, the method can update the last seen time (end time) of the person in the table to current time at block 10. In some embodiments, if the face angle is less than the impression threshold, the method can increase the impression time for the person being tracked by a set time period, e.g., 1 second. For impression time, in one example, the method may check once every second, since the time period for increasing the impression time is 1 second when increasing it.

Referring back to block 9, if the track ID is a new one for the history table, e.g., the track ID does not match an existing track ID in the history table, the method may add the input track ID to the existing historical IDs that are stored the historical table at block 11. In this example, the method can set start time and end time to current time. In this example, the method may also initialize the impression time to 0.

At block 12 of FIG. 8, all new input track ID data and revised existing track ID data may be compiled in storage with timing information for all regions, e.g., all locations 100 being monitored including points of reference 101. After block 12 of the method, an updated history table for tracked IDs is provided. In some embodiments, for all persons in the updated history table, the method can verify them with regions of interest. Each region of interest is a bounding box in the video frame, and it defines a part of the video frame that is partially interested by users of the methods, systems and computer program products described herein. The location of each person in block 12 is used to determine whether this person belongs one region of interest or not. The method may employ use the whole frame as the default region of interest 100, unless otherwise configured, e.g., configured to a specific point of interest 101.

For each region of interest, the method can output results for three applications. In some embodiments, the crowd characterization characterizing designator 500 also includes three applications, e.g., a crowd counter 530, dwell time timer 540, and opportunity to see (OTS) calculator 550.

Block 13 shows the output for crowd counting. In some embodiments, the method can count the number of the persons using the number of track ID. In one example, crowd counting can be performed by a crowd counter 530. Further details regarding the crowd counter 530 are provided in the description of the crowd characterization designator 500 provided in FIG. 5.

Block 14 shows the output of a time calculation. The method may employ the time difference between end time and start time as the duration of a person 102, 103, 104 staying before a camera 105. The time calculation may be performed by a dwell time timer 540. Further details regarding the dwell time timer 540 are provided in the description of the crowd characterization designator 500 provided in FIG. 5.

Block 15 shows the output of an opportunity to see (OTS) calculation. The OTS results can include the dwell time, and the impression time. The OTS calculation can also incorporates the demographic information, e.g., age, gender and position (e.g., the angle of the person facing the point of interest 101). This information is obtained from the type characteristics that have been tied to the track identification.

The outputs from the crowd counting, time calculation (dwell time timer 540) and the OTS calculation 550 all be automatically launched from the crowd characterizing designator 500 to an application that matches this information to advertising content. The matched advertising content is displayed at the point of reference. This provides targeted advertising to the type characteristics, gender and age, of the individuals being tracked at the appropriate locations being monitored and times. The advertising application can play content at the at least one point of reference 101 for viewing that matches the type classification of the viewers 102, 103, 104 in the region being monitored 100. The advertising application can play the content at the point of reference when the measuring for the probability of viewing exceeds a threshold value. The threshold value may be a preset value that indicates enough of the viewership would be interested in the subject matter of the advertising.

In some embodiments, the methods, systems and computer program products that have been described above with reference to FIGS. 1-8 can provide multiple detectors to extract information from a video stream. For example, a people detector 311 can be used to detect persons. A face detector 313 can be used to detect faces. A gender detector 430 can be used to detect gender from faces. An age detector 420 can be used to detect age from faces. A position detector 440 can be used to detect a face pose angle from faces.

In some embodiments, the methods, systems and computer program products can connects persons across frames with history information. For example, a tracker 312 can be employed to track persons, and faces are connected to persons using location information and a connector 314 to assign persons with tracking ID to facial images.

In some embodiments, the methods, systems and computer program products can provide a method to calculate dwell time and a method to calculate impression time.

The methods, systems and computer program products that have been described above with reference to FIGS. 1-8 can support multiple applications. For example, crowd counting can be executed to illustrate the number of persons in a region being monitored. For example, dwell time can be calculated to show the duration of each person staying within the regions being monitored. For example, an opportunity to see (OTS) measurement may be calculated to show the time of a person watching advertisements that can be displayed at points of reference in the location being monitored. Additionally, the systems may have different configurations based on a preferred output to reduce hardware cost.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for characterizing a crowd comprising:
recording a video stream of individuals at a location having at least one reference point for viewing;
extracting the individuals from frames of the video streams;
assigning tracking identification values to the individuals that have been extracted from the video streams;
measuring at least one type classification from the individuals having the tracking identification values; and
generating a crowd designation further characterizing the individuals having the tracking identification values in the location, the crowd designation comprising at least one measurement of probability that the individuals having the tracking identification values in the location view the at least one reference point for viewing.

2. The computer-implemented method of claim 1 further comprising launching an advertising application, wherein the advertising application plays content at the at least one point of reference for viewing that matches the type classification, the advertising application playing the content at the point of reference when the measuring for the probability of viewing exceeds a threshold value.

3. The computer-implemented method of claim 1, wherein the type classification is selected from the group consisting of age, gender, position, and combinations thereof for the individuals having the tracking identification values.

4. The computer-implemented method of claim 1, wherein the assigning of the tracking identification values to the individuals that have been extracted from the video streams comprises:
detecting the individuals from the frames of the video stream;
assigning the tracking identification values to the individuals detected from the frames of the video stream;
detecting faces from the frames of the video stream; and
matching the faces to the individuals having the tracking identification values.

5. The computer-implemented method of claim 1, wherein the measuring at least one type classification from the individuals having the tracking identification values comprises detecting an angle of the individual relative to the at least one reference point for viewing.

6. The computer-implemented method of claim 1, wherein the crowd designation is selected from the group consisting of a counting of the population of a crowd of the individuals, a dwell time measurement for the individuals in the crowd, an opportunity to see (OTS) measurement for the individuals in the crowd, and combinations thereof.

7. The computer-implemented method of claim 1, wherein the tracking identification values is anonymous.

8. A system for characterizing a crowd method, comprising:
a hardware processor; and
a memory that stores a computer program product, which, when executed by the hardware processor, causes the hardware processor to:
record a video stream of individuals at a location having at least one reference point for viewing;
extract the individuals from frames of the video streams;
assign tracking identification values to the individuals that have been extracted from the video streams;
measure at least one type classification from the individuals having the tracking identification values; and
generate a crowd designation further characterizing the individuals having the tracking identification values in the location, the crowd designation comprising at least one measurement of probability that the individuals having the tracking identification values in the location view the at least one reference point for viewing.

9. The system of claim 8, wherein the computer program product further causes the hardware processor to launch an advertising application, wherein the advertising application plays content at the at least one point of reference for viewing that matches the type classification, the advertising application playing the content at the point of reference when the measuring for the probability of viewing exceeds a threshold value.

10. The system of claim 8, wherein the type classification is selected from the group consisting of age, gender, position, and combinations thereof for the individuals having the tracking identification values.

11. The system of claim 8, wherein the assign of the tracking identification values to the individuals that have been extracted from the video streams comprises:
detecting the individuals from the frames of the video stream;
assigning the tracking identification values to the individuals detected from the frames of the video stream;
detecting faces from the frames of the video stream; and
matching the faces to the individuals having the tracking identification values.

12. The system of claim 8, wherein the measure of the at least one type classification from the individuals having the tracking identification values comprises detecting an angle of the individual relative to the at least one reference point for viewing.

13. The system of claim 8, wherein the crowd designation is selected from the group consisting of a counting of the population of a crowd of the individuals, a dwell time measurement for the individuals in the crowd, an opportunity to see (OTS) measurement for the individuals in the crowd, and combinations thereof.

14. The system of claim 8, wherein the tracking identification values is anonymous.

15. A computer program product for characterizing a crowd, the computer program product comprises a computer readable storage medium having computer readable program code embodied therewith, the program instructions executable by a processor to cause the processor to:
record, using the processor, a video stream of individuals at a location having at least one reference point for viewing;
extract, using the processor, the individuals from frames of the video streams;
assign, using the processor, tracking identification values to the individuals that have been extracted from the video streams;
measure, using the processor, at least one type classification from the individuals having the tracking identification values; and
generate, using the processor, a crowd designation further characterizing the individuals having the tracking identification values in the location, the crowd designation comprising at least one measurement of probability that the individuals having the tracking identification values in the location view the at least one reference point for viewing.

16. The computer program product of claim 15 further comprising to launch, using the processor, an advertising application, wherein the advertising application plays content at the at least one point of reference for viewing that matches the type classification, the advertising application playing the content at the point of reference when the measuring for the probability of viewing exceeds a threshold value.

17. The computer program product of claim 15, wherein the type classification is selected from the group consisting of age, gender, position, and combinations thereof for the individuals having the tracking identification values.

18. The computer program product of claim 15, wherein the assigning of the tracking identification values to the individuals that have been extracted from the video streams comprises:
detecting the individuals from the frames of the video stream;
assigning the tracking identification values to the individuals detected from the frames of the video stream;
detecting faces from the frames of the video stream; and
matching the faces to the individuals having the tracking identification values.

19. The computer program product of claim 15, wherein the measuring at least one type classification from the individuals having the tracking identification values comprises detecting an angle of the individual relative to the at least one reference point for viewing.

20. The computer program product of claim 15, wherein the crowd designation is selected from the group consisting of a counting of the population of a crowd of the individuals, a dwell time measurement for the individuals in the crowd, an opportunity to see (OTS) measurement for the individuals in the crowd, and combinations thereof.
